(19) United States
(12) Patent Application Publication
(10) Pub. No.: US 2013/0069825 A1
(43) Pub. Date: Mar. 21, 2013

(54) METHODS, CIRCUITS AND SYSTEMS FOR GENERATING NAVIGATION BEACON SIGNALS

(71) Applicant: Solon Jose Spiegel, Tel Aviv (IL)

(72) Inventor: Solon Jose Spiegel, Tel Aviv (IL)

(73) Assignee: RIO SYSTEMS LTD., Givat Shmuel (IL)

(21) Appl. No.: 13/238,202

(22) Filed: Sep. 21, 2011

(51) Int. Cl. G01S 19/02

(52) U.S. Cl. 342/357.395

(57) ABSTRACT

Disclosed are methods, circuits and systems for generating satellite navigation beacon signals. There is provided a multi-system beacon transmitter adapted to generate a beacon signal for navigation systems. The multi-system beacon transmitter may include: (1) a baseband data processor adapted to process a navigation data based data signal in baseband; (2) an adjustable radio-frequency (RF) transmission module adapted to process and up-convert the baseband data signal, and further adapted to transmit the RF signal via one or more functionally associated antenna(s); and (3) a multi-system interfacing module adapted to convey the navigation signal and to control the RF transmission module based on a determined RF transmission mode. The determined RF transmission mode may be selected from a set of navigation system transmission modes. The need for external frequency selectable elements (e.g. filters) may be obviated.

### FIELD OF THE INVENTION

Some embodiments relate generally to the field of navigation systems and, more particularly, to methods, circuits and systems for generating navigation beacon signals.

### BACKGROUND

Navigation systems are not new. From antiquity, sailors mastered the art of knowing their position and direction by staying in sight of land, learning the wind currents and aligning themselves relative to the position of the sun, moon and star constellations. Early tools such as the Kamal (cross-staff) and later tools such as the magnetic compass and mariner's astrolabe, allowed the user to make accurate calculations of position and direction.

Modern global navigation systems, e.g. Global Positioning System (GPS) and GLONASS are ubiquitous. Additional global navigation systems, e.g. Galileo and COMPASS are under development. Cell phones, smart phones, laptops, tablets, watches and dedicated navigation devices have integrated global navigation transceivers. In addition to global positioning, global satellite navigation systems can provide turn-by-turn directions when combined with integrated maps.

Configurable transmitters for global navigation systems have commercial applications such as location services and warning systems, in addition to military applications.

Traditionally, connectivity between a digital navigation baseband circuit and an antenna requires multiple channels. Each channel comprises a dedicated radio frequency (RF) filter to suppress undesired signals, while delivering the selected transmission frequency band to the antenna with minimum degradation to the carrier-to-noise ratio. This traditional design suffers from the need for external components, such as filters (which are proportionally larger and more expensive than the circuit), to select between individual frequency bands.

A configurable transmitter supporting multiple global navigation systems and comprising a single RF transceiver integrated circuit (IC) is most advantageous. A single RF transceiver IC with a navigation baseband circuit, no external components and improved system performance is ideal.

There is thus a need in the field of navigation systems for improved methods, circuits and systems for generating navigation beacon signals.

### SUMMARY OF THE INVENTION

The present invention includes methods, circuits and systems for generating satellite navigation beacon signals. According to some embodiments of the present invention, there is provided a multi-system beacon transmitter adapted to generate a beacon signal for navigation systems. According to further embodiments of the present invention, the multi-system beacon transmitter may include: (1) a baseband data processor adapted to process a navigation data based data signal in baseband; (2) an adjustable radio-frequency (RF) transmission module adapted to process and up-convert the baseband data signal, and further adapted to transmit the RF signal via one or more functionally associated antenna(s); and (3) a multi-system interfacing module adapted to convey the navigation signal and control the RF transmission module based on a determined RF transmission mode. The determined RF transmission mode may be selected from a set of navigation system transmission modes. According to further embodiments of the present invention, the need for external frequency selectable elements (e.g. filters) may be obviated.

According to some embodiments of the present invention, the adjustable RF transmission module may comprise one or more complex frequency conversion unit(s). According to further embodiments of the present invention, a complex frequency conversion unit may be adapted to substantially attenuate noise (e.g. unwanted signals).

According to some embodiments of the present invention, the adjustable RF transmission module may comprise one or more gain control units. According to further embodiments of the present invention, a gain control unit may be adapted to adjust the gain of a data signal in one or more intermediate frequency (IF) stages.

According to some embodiments of the present invention, the adjustable RF transmission module may comprise a local oscillator with a variable/programmable signal based on a desired operational frequency for a selected navigation system transmission mode.

According to some embodiments of the present invention, the multi-system interfacing module may adjust a local oscillator functionally associated with the adjustable RF transmission module based on a selected navigation system transmission mode. The local oscillator may be adjusted to a desired center carrier frequency associated with the selected navigation system transmission mode.

According to some embodiments of the present invention, the multi-system beacon transmitter may comprise a radio beacon, a radio navigation beacon, a non-directional (radio) beacon (NDB) and/or distance measuring equipment (DME). According to further embodiments of the present invention, the multi-system beacon transmitter may generate a beacon signal compliant with global satellite navigation systems, local navigation systems (e.g. navigation in a commercial or residential setting) and/or alert signaling systems. The generated beacon signal may be compliant with simulators, emulators and/or test equipment of or relating to one or more navigation and/or alert signal systems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A shows a block diagram of a multi-system beacon transmitter including multiple digital navigation baseband modules, navigation transmitter integrated circuits (ICs) and radio frequency (RF) filters (prior art);

FIG. 1B shows a block diagram of a multi-system beacon transmitter including a single digital navigation baseband module, multiple navigation transmitter ICs and (RF) filters (prior art);

FIG. 1C shows a block diagram of a multi-system beacon transmitter including a single digital navigation baseband module, a single navigation transmitter IC and multiple RF filters (prior art);

FIG. 1D shows a block diagram of a multi-system beacon transmitter including a single digital navigation baseband module, a single navigation transmitter IC, an intermediate frequency (IF) filter and multiple RF filters (prior art);

FIG. 2 is a chart of global navigation systems frequency bands (prior art);

FIG. 3A shows an exemplary block diagram of a multi-system beacon transmitter, according to some embodiments of the present invention;

FIG. 3B shows an exemplary block diagram of a multi-system interfacing module and adjustable RF transmission module (e.g. navigation transmitter IC), according to some embodiments of the present invention;

FIG. 4 is a flowchart describing the method by which the multi-system interfacing module and adjustable RF transmission module may operate, according to some embodiments of the present invention; and

FIG. 5 shows an exemplary integrated circuit (IC) architecture layout of the exemplary multi-system interfacing module and adjustable RF transmission module, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, portable media players, cell phones, mobile devices, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories.

According to some embodiments of the present invention, there includes a multi-system beacon transmitter for navigation systems. The transmitter may comprise: an adjustable radio-frequency (RF) transmission module adapted to transmit a satellite navigation data signal and comprising one or more complex frequency converters and one or more gain control units adapted to process a navigation data based data signal before transmission; and a multi-system interfacing module adapted to control the adjustable RF transmission module based on a determined RF transmission mode.

According to some embodiments of the present invention, the RF transmission module may comprise triple complex conversion architecture. The RF transmission module may further comprise three complex frequency converters. The RF transmission module may further comprise three gain control units. According to further embodiments of the present invention, the RF transmission module may be integrated on a single integrated circuit.

According to some embodiments of the present invention, the determined RF transmission mode may correspond to a selected transmitter center frequency. According to further embodiments of the present invention, the multi-system interfacing module may be further adapted to adjust a local oscillator of the adjustable RF transmission module in response to the selected center frequency.

According to some embodiments of the present invention, the determined RF transmission mode may correspond to a selected navigation system beacon protocol. The determined RF transmission mode may correspond to a Global Positioning System (GPS) beacon protocol. The determined RF transmission mode may correspond to a Galileo beacon protocol. The determined RF transmission mode may correspond to a GLONASS beacon protocol. The determined RF transmission mode may correspond to a COMPASS beacon protocol.

According to some embodiments of the present invention, the adjustable RF transmission module may be adapted to receive a navigation data based data signal from a functionally associated baseband data processor. According to further embodiments of the present invention, the baseband data processor, the adjustable RF transmission module and the multi-system interfacing module may be fabricated on the same die.

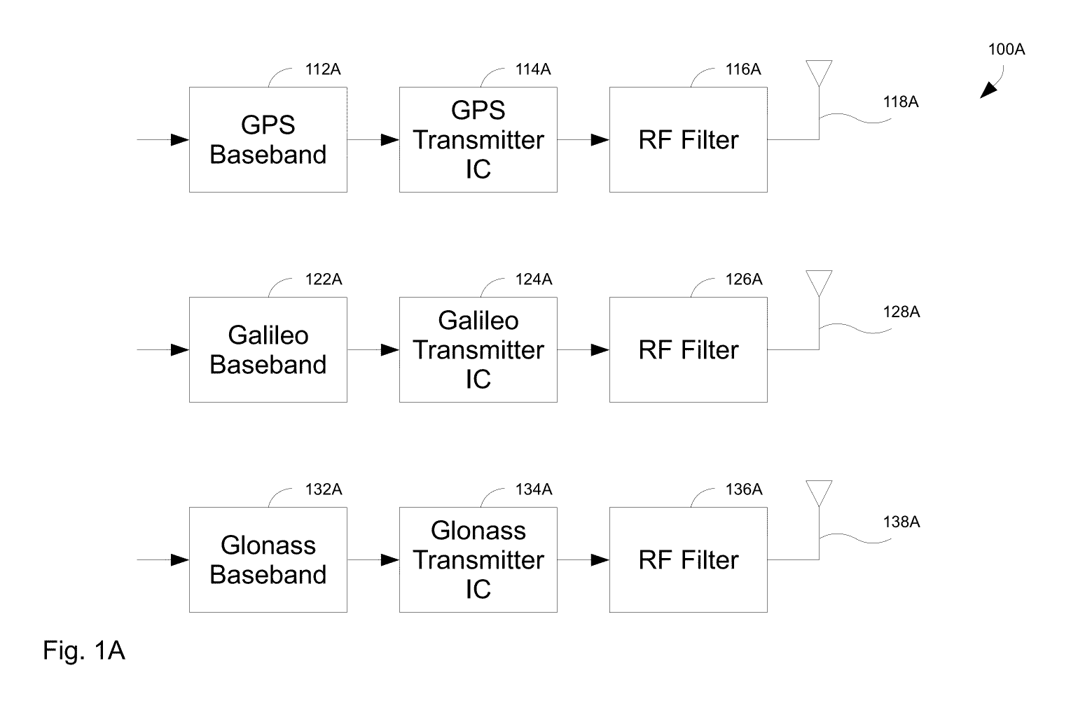

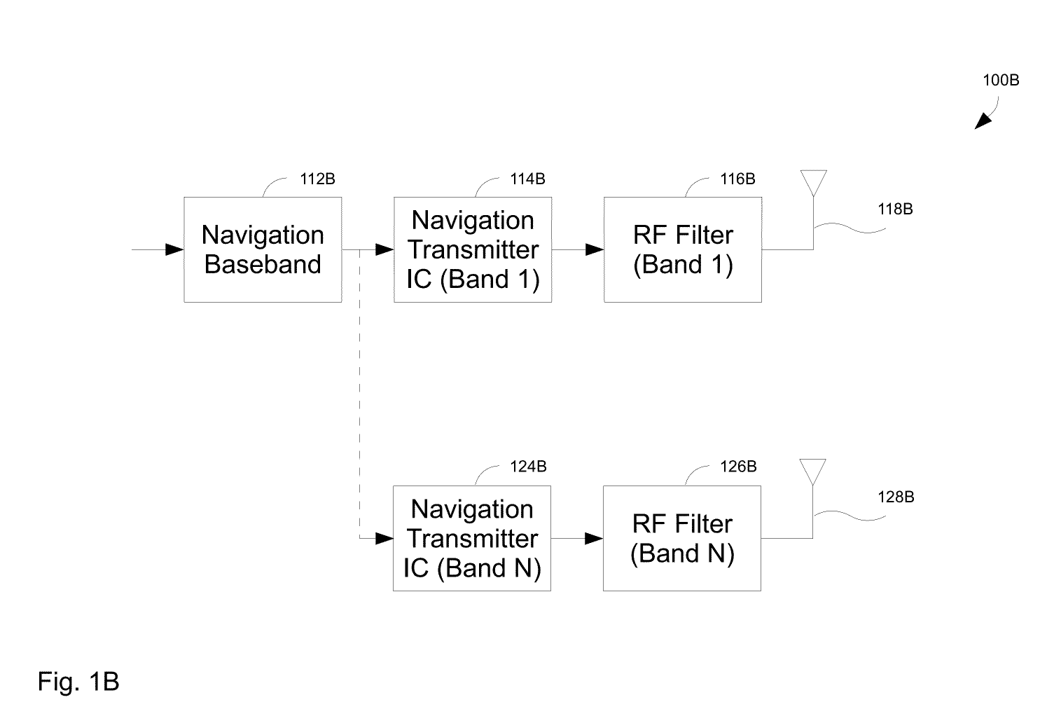

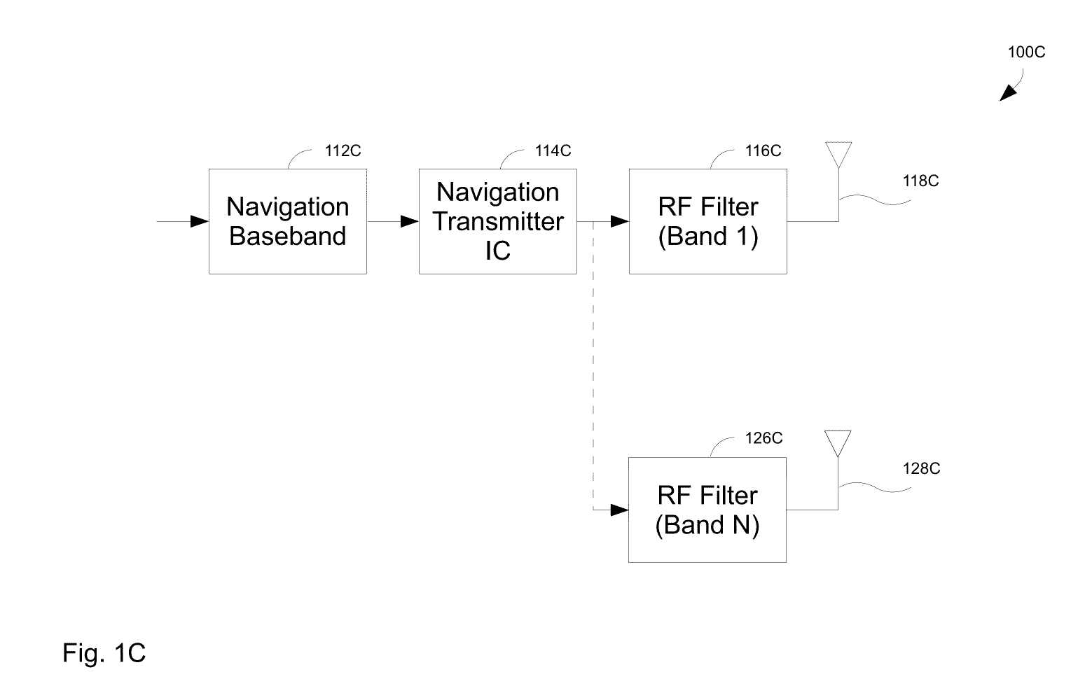

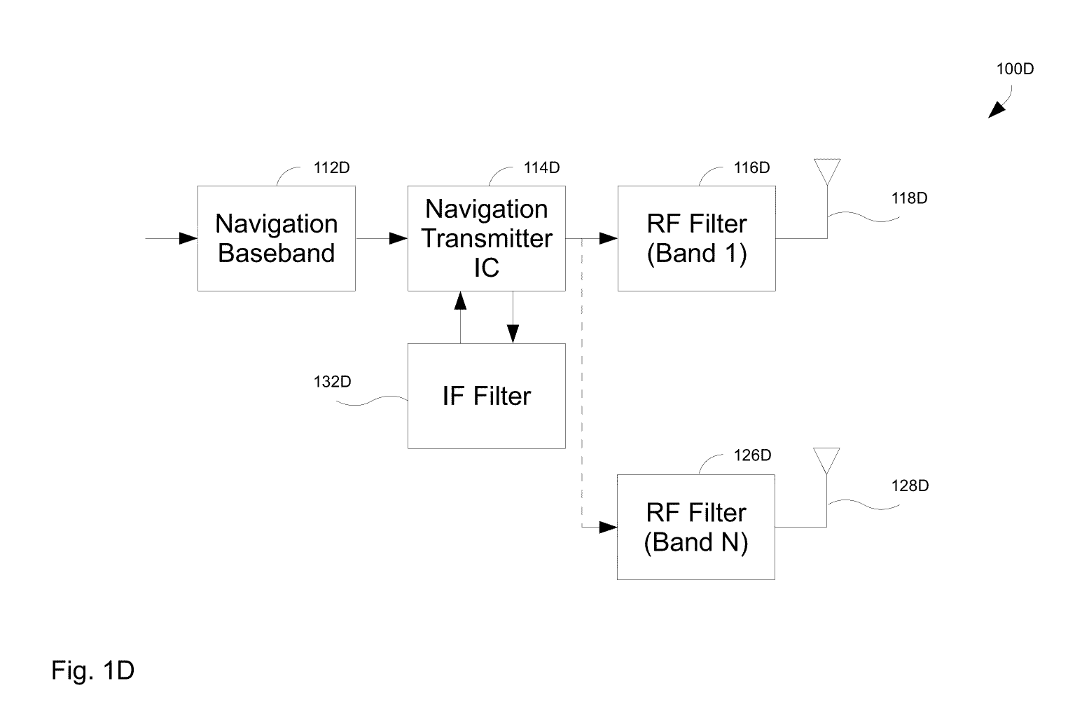

Now turning to FIG. 1A, there is shown a block diagram of a multi-system beacon transmitter (100A) including multiple digital navigation baseband modules, navigation transmitter integrated circuits (ICs) and radio frequency (RF) filters (prior art). Digital navigation baseband modules (112A, 122A and 132A) may represent proprietary baseband modules adapted to generate a specified global navigation data signal (e.g. GPS, Galileo, GLONASS or COMPASS). Navigation transmitter integrated circuits (ICs—114A, 124A and 134A) may represent proprietary transmission chains adapted to process a specified global navigation data signal (e.g. GPS, Galileo, GLONASS or COMPASS) for transmission. Radio frequency (RF) filters (116A, 126A and 136A) may be adapted to filter unwanted noise from their respective transmission chain and may be external filters.

Now turning to FIG. 1B, there is shown a block diagram of a multi-system beacon transmitter (100B) including a single digital navigation baseband module, multiple navigation transmitter ICs and (RF) filters (prior art). Digital navigation baseband module (112B) may represent a multi-system baseband module adapted to generate one or more global navigation data signals (e.g. GPS, Galileo, GLONASS and COMPASS). Navigation transmitter ICs (114B and 124B) may represent proprietary transmission chains adapted to process a specified global navigation data signal (e.g. GPS, Galileo, GLONASS or COMPASS) for transmission. RF filters (116B and 126B) may be adapted to filter unwanted noise from their respective transmission chain and may be external filters.

Now turning to FIG. 1C, there is shown a block diagram of a multi-system beacon transmitter (100C) including a single digital navigation baseband module, a single navigation transmitter IC and multiple RF filters (prior art). Digital navigation baseband module (112C) may represent a multi-system baseband module adapted to generate one or more global navigation data signals (e.g. GPS, Galileo, GLONASS and COMPASS). Navigation transmitter IC (114C) may represent a multi-system transmission chain adapted to process one or more global navigation data signals (e.g. GPS, Galileo, GLONASS or COMPASS) for transmission. RF filters (116C and 126C) may be adapted to filter unwanted noise from their respective transmission chain and may be external filters.

Now turning to FIG. 1D, there is shown a block diagram of a multi-system beacon transmitter (100D) including a single digital navigation baseband module, a single navigation transmitter IC, an intermediate frequency (IF) filter and multiple RF filters (prior art). Digital navigation baseband module (112D) may represent a multi-system baseband module adapted to generate one or more global navigation data signals (e.g. GPS, Galileo, GLONASS and COMPASS). Navigation transmitter IC (114D) may represent a multi-system transmission chain adapted to process one or more global navigation data signals (e.g. GPS, Galileo, GLONASS or COMPASS) for transmission. RF filters (116D and 126D) may be adapted to filter unwanted noise from their respective transmission chain and may be external filters. The IF filter (132D) may be adapted for multiple frequency conversion of the baseband signal.

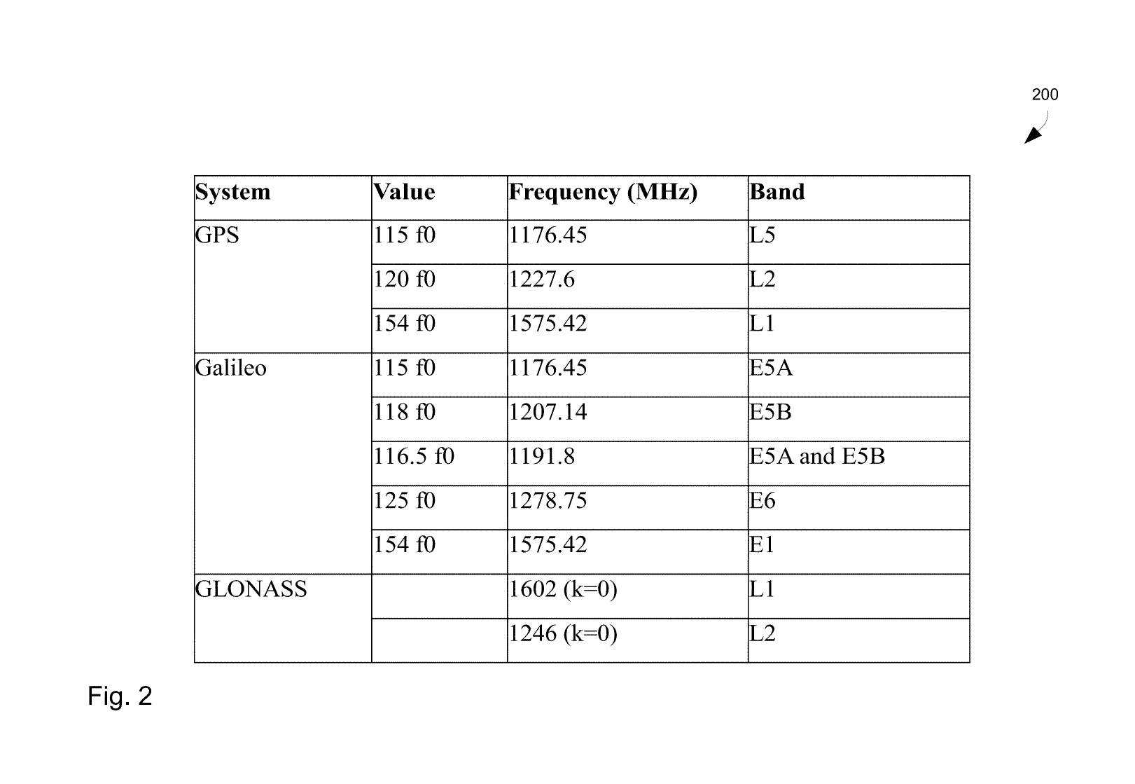

Now turning to FIG. 2, there is shown a chart (200) of global navigation systems frequency bands (prior art). Upon selection of a desired transmission mode, an adjustable radio-frequency (RF) transmission module may transmit a RF signal centered on a frequency listed in the chart (200). For a given system, transmission frequencies may be set such that each satellite transmits at a given multiple of a reference frequency f0 (e.g. f0=10.23 MHz for GPS) and in a specific band.

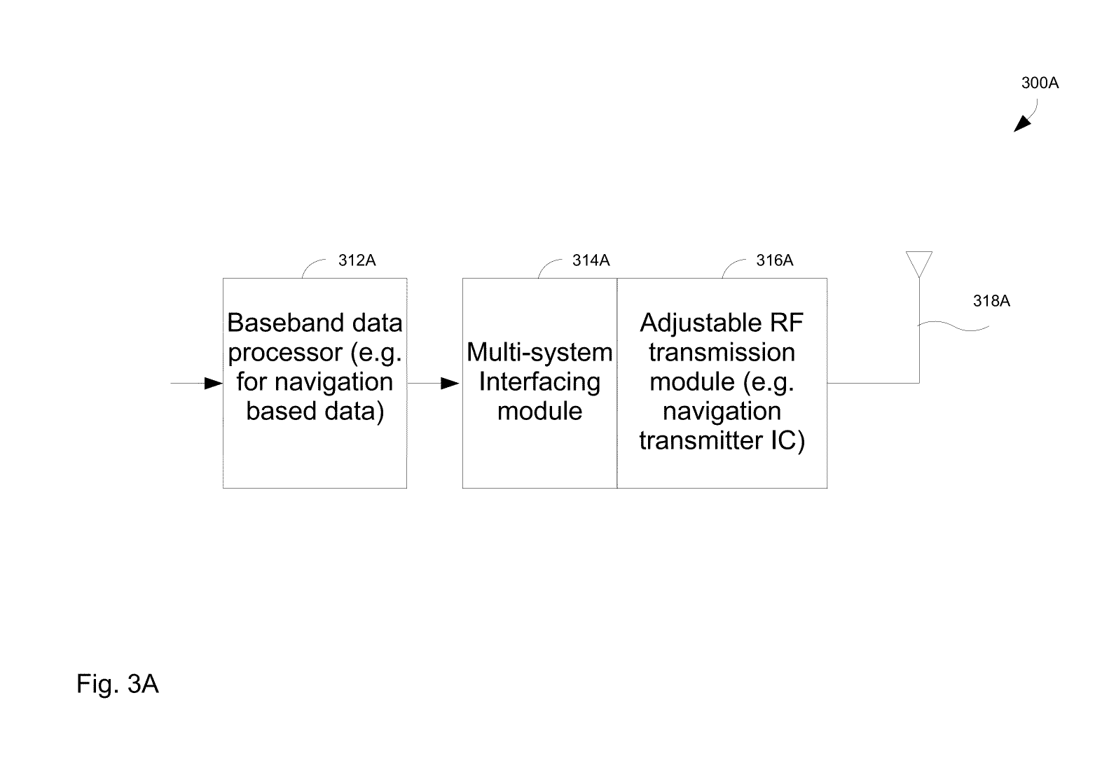

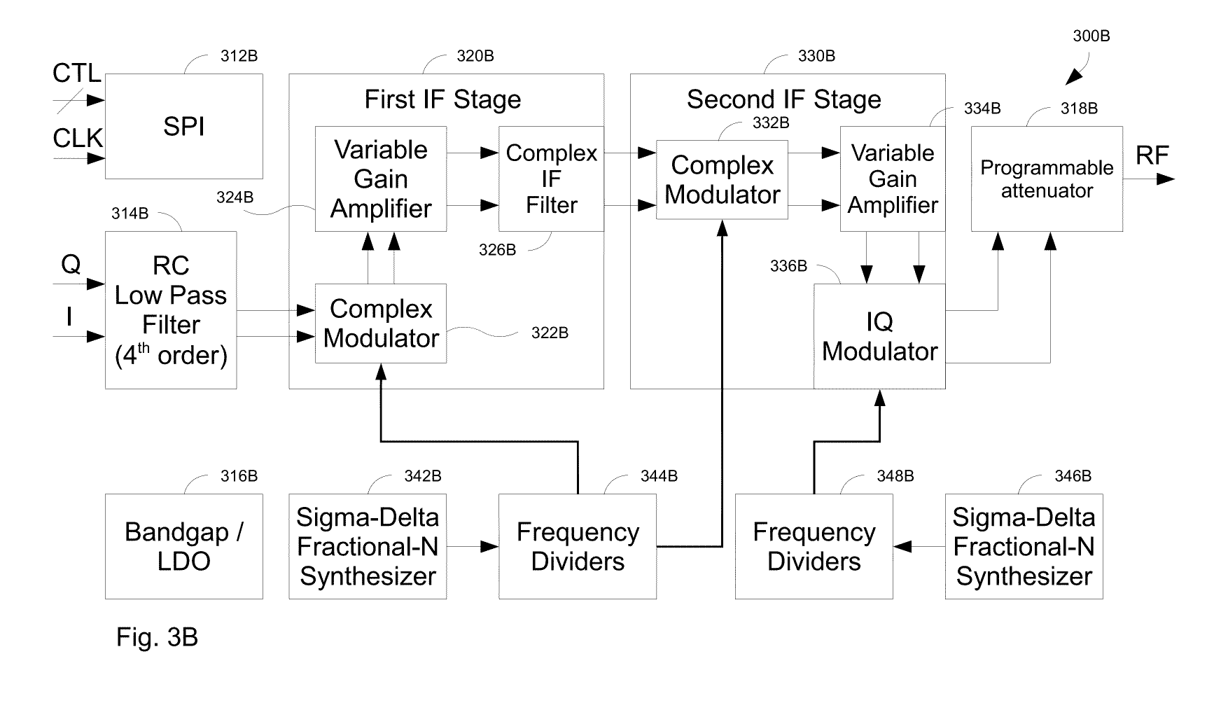

Now turning to FIG. 3A, there is shown an exemplary block diagram of a multi-system beacon transmitter (300A), according to some embodiments of the present invention. According to some embodiments of the present invention, the multi-system beacon transmitter (300A) may include a baseband data processor (312A—e.g. for navigation based data), a multi-system interfacing module (314A) and an adjustable RF transmission module (316A—e.g. navigation transmitter IC).

According to some embodiments of the present invention, baseband data processor (312A) may comprise a multi-system baseband module adapted to generate one or more global satellite navigation data signals (e.g. GPS, Galileo, GLONASS and COMPASS). According to further embodiments of the present invention, adjustable RF transmission module (316A) may represent a multi-system transmission chain adapted to process one or more global satellite navigation data signals (e.g. GPS, Galileo, GLONASS or COMPASS) for transmission. RF transmission module (316A) may transmit the global satellite navigation data signal via a functionally associated antenna (318A).

According to further embodiments of the present invention, the multi-system interfacing module (314A) may be adapted to control said adjustable RF transmission module (316A) based on a determined global satellite navigation mode. The determined global satellite navigation mode may be based on a global satellite navigation data signal generated by the baseband data processor (312A).

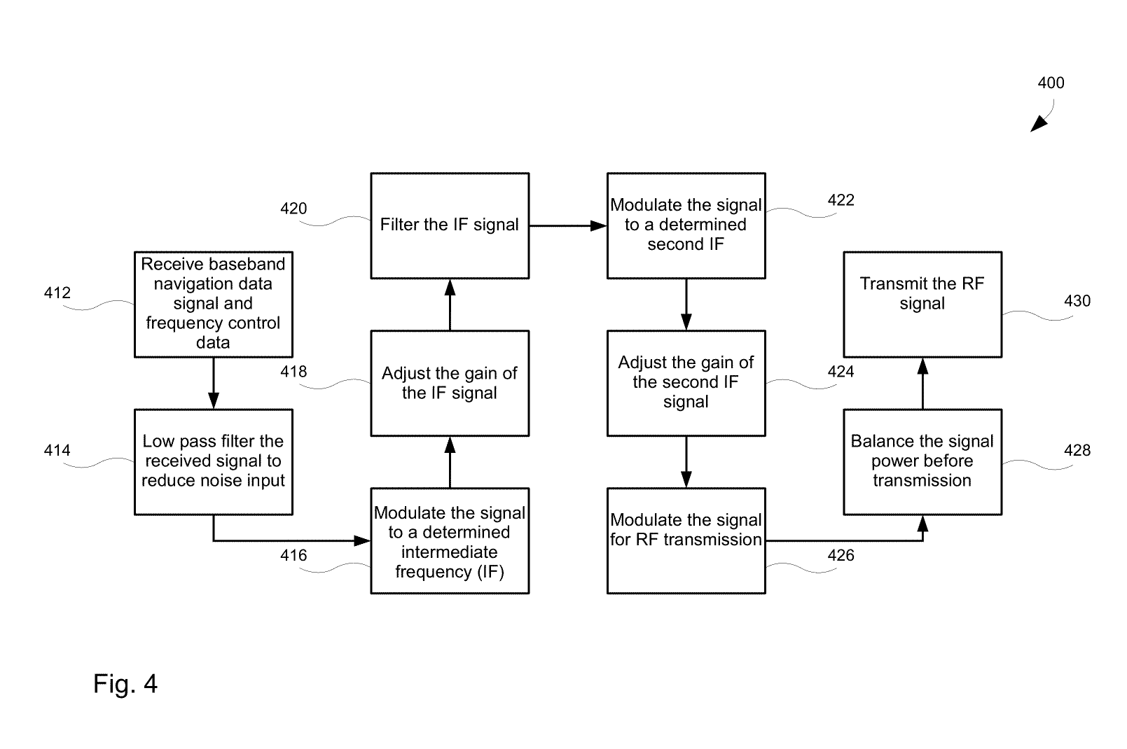

Now turning to FIG. 3B, there is shown an exemplary block diagram of a multi-system interfacing module and adjustable RF transmission module (300B), according to some embodiments of the present invention. The operation of the multi-system interfacing module and adjustable RF transmission module (300B) may be described in view of FIG. 4, showing a flowchart (400) describing the method by which the multi-system interfacing module and adjustable RF transmission module (300B) may operate, according to some embodiments of the present invention.

According to some embodiments of the present invention, the multi-system interfacing module and adjustable RF transmission module (300B) may include an interface bus or input device e.g. serial peripheral interface (SPI—312B) that may receive a control signal relating to a selected mode of operation. The control signal may contain frequency control data (412). The SPI (312B) may also receive a clock signal adapted to provide an accurate clock reference for functionally associated circuits and/or modules.

According to some embodiments of the present invention, the multi-system interfacing module and adjustable RF transmission module (300B) may include a voltage regulator e.g. low-dropout (LDO) regulator (316B) adapted to provide a reference current and/or a reference voltage for functionally associated circuits and/or modules. According to further embodiments of the present invention, the LDO (316B) may comprise a bandgap reference adapted to provide a stable voltage reference.

According to some embodiments of the present invention, a baseband navigation data signal may be received (412) by an input filter e.g. RC low pass filter (4^{th} order) 314B. The data received may be complex analog data (i.e. Amplitude/Phase or I/Q data). According to further embodiments of the present invention, the received signal may be filtered (414) to reduce noise on the input signal.

According to some embodiments of the present invention, the baseband navigation data signal may be sent to a complex modulator (322B) to modulate (416) the signal to a determined intermediate frequency (IF). The determined IF may be based on the selected mode of operation. According to further embodiments of the present invention, the determined IF may be supplied by a combination of a sigma-delta fractional-N synthesizer (342B) and frequency dividers (344B) adapted to maintain a selected frequency. According to further embodiments of the present invention, the IF signal may be processed by a variable gain amplifier (324B) adapted to adjust the gain (418) of the IF signal. The signal may be filtered (420) by complex IF filter (326B) to reduce noise on the IF signal.

According to some embodiments of the present invention, the baseband navigation data signal may be sent to a complex modulator (332B) to modulate (422) the signal to a determined second IF. The determined second IF may be based on the selected mode of operation. According to further embodiments of the present invention, the determined second IF may be supplied by a combination of a sigma-delta fractional-N synthesizer (342B) and frequency dividers (344B) adapted to maintain a selected frequency. According to further embodiments of the present invention, the second IF signal may be processed by a variable gain amplifier (334B) adapted to adjust the gain (424) of the IF signal.

According to some embodiments of the present invention, an IQ modulator (336B) may modulate (426) a received second IF signal for RF transmission. The determined RF may be based on the selected mode of operation. According to further embodiments of the present invention, the determined RF may be supplied by a combination of a sigma-delta fractional-N synthesizer (346B) and frequency dividers (348B) adapted to maintain a selected frequency.

According to further embodiments of the present invention, a programmable attenuator (318B) may balance (428) the RF signal power before transmission. The programmable attenuator may maintain an output noise floor density at thermal noise level at a given temperature. The output noise density may be maintained at kT level (where k is the Boltzmann constant and T is the temperature), regardless of the power level of the RF signal. According to further embodiments of the present invention, the RF signal may be transmitted (430) via one or more functionally associated antennas.

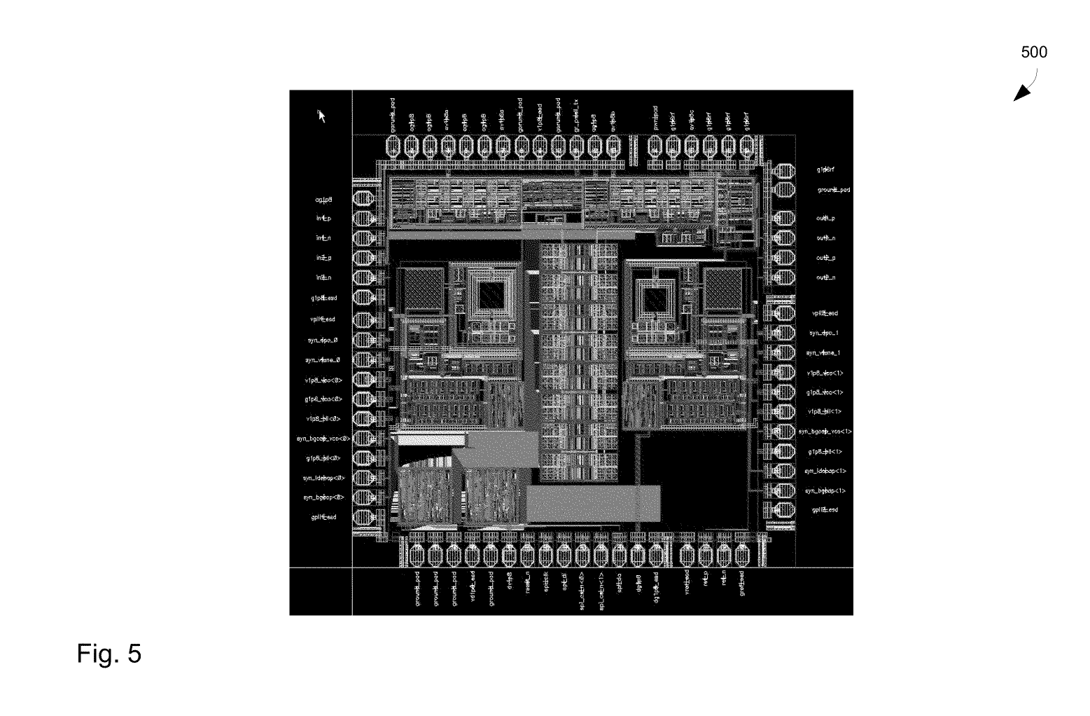

Now turning to FIG. 5, there is shown an exemplary integrated circuit (IC) architecture layout of the exemplary multi-system interfacing module and adjustable RF transmission module (500), according to some embodiments of the present invention. In this nonexclusive example, the die is 2.4 mm×2.4 mm.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A multi-system beacon transmitter for navigation systems comprising:
an adjustable radio-frequency (RF) transmission module adapted to transmit a satellite navigation data signal and comprising one or more complex frequency converters and one or more gain control units adapted to process a navigation data based data signal before transmission; and
a multi-system interfacing module adapted to control said adjustable RF transmission module based on a determined RF transmission mode.

2. The transmitter according to claim 1, wherein said RF transmission module comprises triple complex conversion architecture.

3. The transmitter according to claim 2, wherein said RF transmission module comprises three complex frequency converters.

4. The transmitter according to claim 2, wherein said RF transmission module comprises three gain control units.

5. The transmitter according to claim 2, wherein said RF transmission module is integrated on a single integrated circuit.

6. The transmitter according to claim 1, wherein the determined RF transmission mode corresponds to a selected transmitter center frequency.

7. The transmitter according to claim 6, wherein said multi-system interfacing module is further adapted to adjust a local oscillator of said adjustable RF transmission module in response to the selected center frequency.

8. The transmitter according to claim 1, wherein the determined RF transmission mode corresponds to a selected navigation system beacon protocol.

9. The transmitter according to claim 8, wherein the determined RF transmission mode corresponds to a Global Positioning System (GPS) beacon protocol.

10. The transmitter according to claim 8, wherein the determined RF transmission mode corresponds to a Galileo beacon protocol.

11. The transmitter according to claim 8, wherein the determined RF transmission mode corresponds to a GLONASS beacon protocol.

12. The transmitter according to claim 8, wherein the determined RF transmission mode corresponds to a COMPASS beacon protocol.

13. The transmitter according to claim 1, wherein said adjustable RF transmission module is adapted to receive a navigation data based data signal from a functionally associated baseband data processor.

14. The transmitter according to claim 13, wherein said baseband data processor, said adjustable RF transmission module and said multi-system interfacing module are fabricated on the same die.
